(19) United States
(12) Patent Application Publication
(10) Pub. No.: US 2026/0267084 A1
(43) Pub. Date: Sep. 10, 2026

(54) LASER MODULE, OPTICAL ENGINE, AND XR GLASSES

(71) Applicant: TDK Corporation, Tokyo (JP)

(72) Inventor: Yusuke SHIGETA, Tokyo (JP)

(73) Assignee: TDK Corporation, Tokyo (JP)

(21) Appl. No.: 19/557,453

(22) Filed: Mar. 5, 2026

(30) Foreign Application Priority Data
Mar. 7, 2025 (JP) 2025-036314

(51) Int. Cl. G02B 6/42; G02B 27/01

(52) U.S. Cl. CPC G02B 6/42; G02B 6/4202; G02B 27/0172; G02B 2027/0178

(57) ABSTRACT

The laser module comprises a plurality of subcarriers 20, a plurality of laser elements 30 installed on the respective main surfaces of the plurality of subcarriers 20, and an optical waveguide substrate 40 having an optical waveguide layer 50 on its main surface, the optical waveguide layer 50 having an optical waveguide 51 for guiding the laser light respectively emitted from the plurality of laser elements 30. The emission surface 50C of the optical waveguide layer 50 is inclined obliquely with respect to a plane perpendicular to the extension direction of the optical waveguide 51 at the emission surface 50C.

### CROSS-REFERENCE TO RELATED APPLICATION

This application claims a priority, under the Paris Convention, to Japanese Patent Application No. 2025-036314 filed on Mar. 7, 2025, the entirety of which is incorporated herein by reference.

### TECHNICAL FIELD

The present disclosure relates to a laser module, an optical engine, and XR glasses.

### BACKGROUND

XR glasses, such as AR (Augmented Reality) glasses and VR (Virtual Reality) glasses, are expected to be small wearable devices. The key to popularizing wearable devices such as AR glasses and VR glasses is to miniaturize them so that each function fits into the size of a normal pair of glasses.

International Publication No. WO 2021/149450 discloses an integrated optical device that is miniaturized by bonding a base that holds a laser element and a substrate on which an optical waveguide is provided on its surface under the state that the light emission position of the laser element and the position of the optical waveguide are precisely aligned through a metal layer.

FIG. 16 is a schematic plan view for explaining the integrated optical device disclosed in WO 2021/149450. FIG. 17 is a schematic cross-sectional view of the integrated optical device shown in FIG. 16 taken along line A-A'. The reference numerals in the figures correspond to the reference numerals of the constituent elements of the laser module of this embodiment, which will be described later, and thus here only the constituent elements necessary for the explanation will be described.

The integrated optical device shown in FIG. 16 and FIG. 17 comprises a plurality of laser elements 30 (30-1, 30-2, 30-3), which are mounted on respective main surfaces 21 (21-1, 21-2, 21-3) and a plurality of individual subcarriers 20 (20-1, 20-2, 20-3) spaced apart from one another, an optical waveguide layer 50 having an optical waveguide 51 that guides the laser light emitted from the laser elements 30 (30-1, 30-2, 30-3), an optical waveguide substrate 40 on whose surface the optical waveguide layer 50 is provided, and a metal film 70 that bonds the subcarriers 20 (20-1, 20-2, 20-3) and the optical waveguide substrate 40.

As recognized by the present inventor, however, in the integrated optical device disclosed in WO 2021/149450, the laser light guided through the optical waveguide 51 is reflected by the emission surface 50C of the optical waveguide layer 50, and becomes return light to the multiple laser elements 30, which may cause concerns that the oscillation of the laser elements 30 becomes unstable and thus affects the optical characteristics of the laser elements 30.

### SUMMARY

One aspect of the present disclosure provides a laser module that includes a plurality of laser element bases, a plurality of laser elements mounted on the respective main surfaces of the plurality of laser element bases, and an optical waveguide substrate having an optical waveguide layer on its main surface, the optical waveguide layer having an optical waveguide for guiding the laser light respectively emitted from the plurality of laser elements. The optical waveguide layer has at least one emission surface, and each of the emission surface of the optical waveguide layer being inclined obliquely with respect to a plane perpendicular to the extension direction of the optical waveguide at the emission surface.

One aspect of the present disclosure provides a laser module that includes a plurality of laser element bases, a plurality of laser elements mounted on the respective main surfaces of the plurality of laser element bases, and an optical waveguide substrate having an optical waveguide layer on its main surface, the optical waveguide layer having an optical waveguide for guiding the laser light respectively emitted from the plurality of laser elements. The incident surface of the optical waveguide layer is inclined obliquely with respect to a plane perpendicular to the extension direction of the optical waveguide at the incident surface.

One aspect of the present disclosure provides a laser module that includes a plurality of laser element bases; a plurality of laser elements mounted on the respective main surfaces of the plurality of laser element bases; and an optical waveguide substrate having an optical waveguide layer on its main surface, the optical waveguide layer having an optical waveguide for guiding the laser light respectively emitted from the plurality of laser elements. The bonding surface of each of the plurality of laser element bases with the optical waveguide substrate is inclined obliquely with respect to a plane perpendicular to the optical axis of the laser light respectively emitted from the plurality of laser elements.

One aspect of the present disclosure provides an optical engine that includes the laser module, and an optical scanning mirror that scans the light emitted from the laser module.

One aspect of the present disclosure provides XR glasses that includes the optical engine.

### BRIEF DESCRIPTION OF DRAWINGS

FIG. 1 shows a schematic plan view of a laser assembly provided in a laser module according to an embodiment of the present disclosure.

FIG. 2 shows a schematic cross-sectional view of the laser assembly shown in FIG. 1, taken along line A-A'.

FIG. 3 shows a schematic cross-sectional view of the laser assembly shown in FIG. 1, taken along line B-B'.

FIG. 4A shows a schematic perspective view of a laser element base.

FIG. 4B shows a schematic perspective view of an optical waveguide substrate.

FIG. 5 shows a schematic cross-sectional view corresponding to FIG. 2 of a laser assembly according to another configuration example (part 1) different from that shown in FIG. 2.

FIG. 6 shows a schematic cross-sectional view corresponding to FIG. 2 of a laser assembly according to another configuration example (part 2) different from that shown in FIG. 5.

FIG. 7 shows a schematic cross-sectional view corresponding to FIG. 2 of a laser assembly according to another configuration example (part 3) different from that shown in FIG. 6.

FIG. 8 shows a schematic cross-sectional view corresponding to FIG. 3 of a laser assembly according to another configuration example (part 3) different from that shown in FIG. 6.

FIG. 9 shows a schematic cross-sectional view corresponding to FIG. 2 of a laser assembly according to another configuration example (part 4) different from that shown in FIG. 5.

FIG. 10 shows a schematic cross-sectional view corresponding to FIG. 2 of a laser assembly according to another configuration example (part 5) different from that shown in FIG. 6.

FIG. 11 shows a schematic plan view of a laser module according to an embodiment of the present disclosure.

FIG. 12 shows a schematic cross-sectional view of the laser module shown in FIG. 11 cut along the X-Z plane.

FIG. 13 shows a schematic plan view of the laser module shown in FIG. 11 with the cover removed.

FIG. 14 shows a conceptual diagram for explaining XR glasses according to an embodiment of the present disclosure.

FIG. 15 shows a conceptual diagram showing how an image is projected directly onto the retina by laser light emitted from a laser module according to an embodiment of the present disclosure.

FIG. 16 shows a schematic plan view of a portion of a conventional integrated optical device.

FIG. 17 shows a schematic cross-sectional view of the integrated optical device shown in FIG. 16 cut along line A-A'.

### DETAILED DESCRIPTION

The present disclosure can provide a laser module, an optical engine, and XR glasses that can suppress return light from the optical waveguide to the laser element.

Embodiments of a laser module, an optical engine, and XR glasses according to the present disclosure will be described hereinafter with reference to the drawings. Here, it should be noted that the dimensional ratios of the constituent elements in each drawing do not necessarily match the actual dimensional ratios.

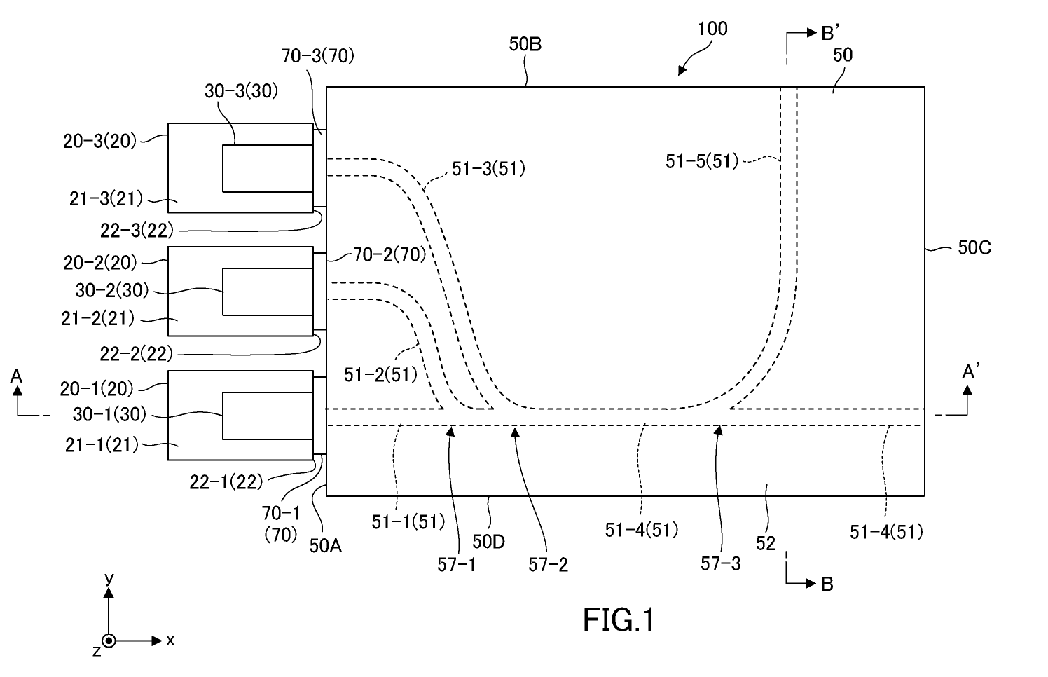

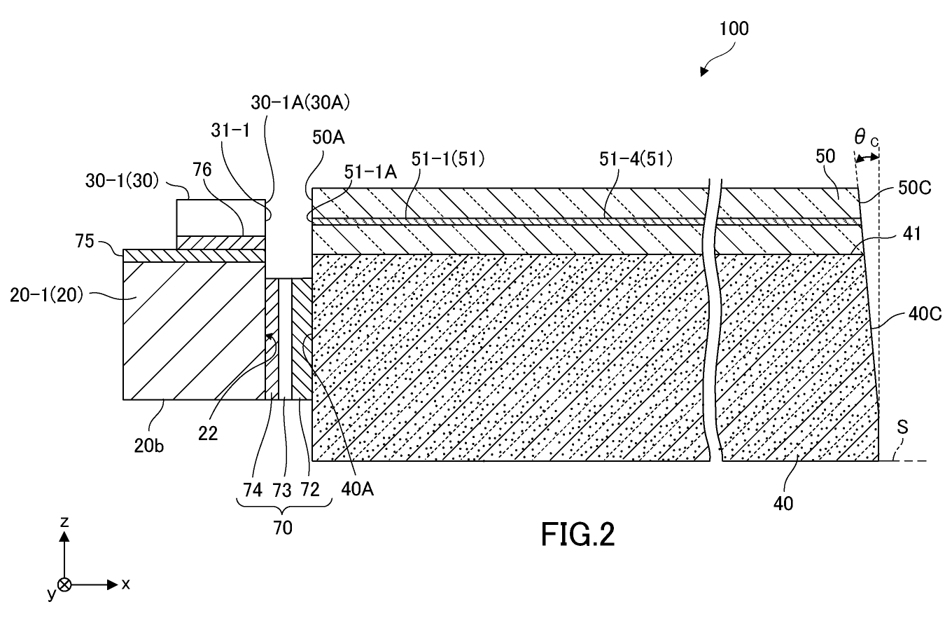

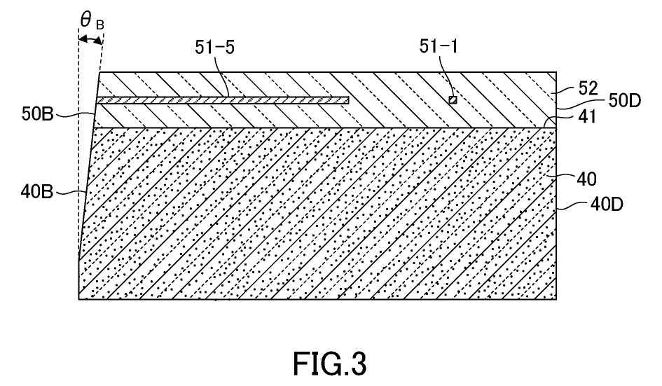

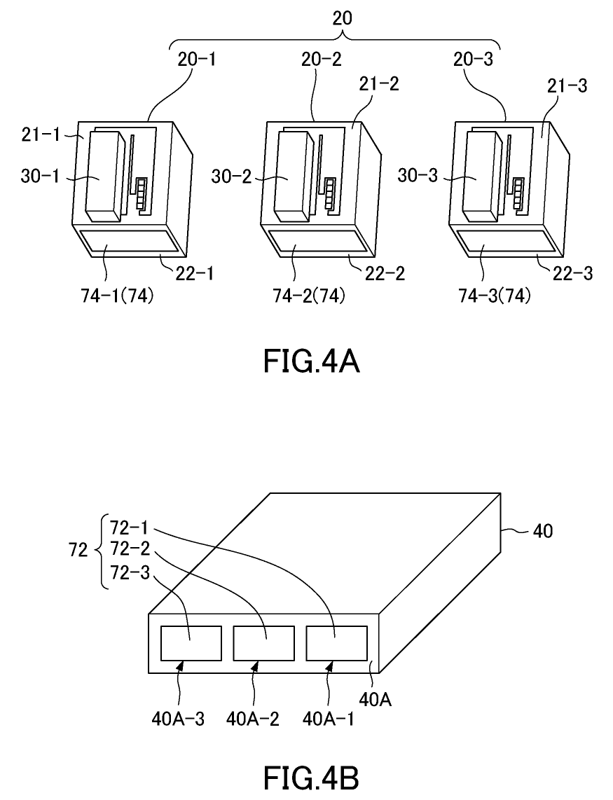

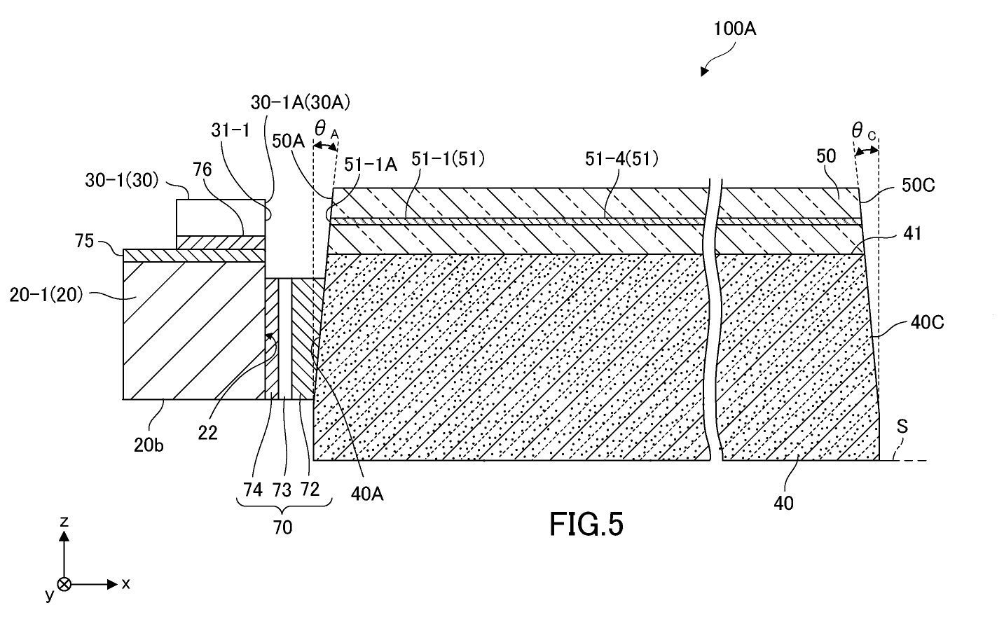

FIG. 1 is a schematic plan view of a portion of a laser assembly included in a laser module of this embodiment. FIG. 2 is a schematic cross-sectional view taken along line A-A' in the laser assembly shown in FIG. 1. FIG. 3 is a schematic cross-sectional view taken along line B-B' in the laser assembly shown in FIG. 1. FIG. 4A is a schematic perspective view of a laser element base, and FIG. 4B is a schematic perspective view of a substrate for optical waveguide.

The laser assembly 100 shown in FIGS. 1 to 3 comprises a plurality of laser element bases (hereinafter also referred to as "subcarriers") 20 (20-1, 20-2, 20-3), a plurality of laser elements 30 (30-1, 30-2, 30-3) mounted on the respective main surfaces 21 (21-1, 21-2, 21-3) of the plurality of subcarriers 20, an optical waveguide substrate 40, and an optical waveguide layer 50 provided on the main surface 41 of the optical waveguide substrate 40.

Various laser elements can be used as the laser element 30. For example, commercially available laser diodes (hereinafter also referred to as "LDs") emitting red light, green light, blue light, near-infrared light, ultraviolet light, etc. can be used. For red light (R), light with a peak wavelength of 630 nm or more and 830 nm or less can be used. For green light (G), light with a peak wavelength of 500 nm or more and 550 nm or less can be used. For blue light (B), light with a peak wavelength of 380 nm or more and 500 nm or less can be used. For near-infrared light, light with a peak wavelength of 830 nm or more and 2000 nm or less can be used.

In the laser assembly 100 shown in FIG. 1, the laser elements 30-1, 30-2, and 30-3 will be described as LDs emitting blue laser light, LDs emitting green laser light, and LDs emitting red laser light, respectively, for the sake of convenience. The laser elements 30-1, 30-2, and 30-3 can be mounted on individual subcarriers 20-1, 20-2, and 20-3, respectively, as bare chips (unpackaged chips), for example. The number of laser elements shown in FIG. 1 is three, but this is just an example, and any number more than one can be used.

The subcarriers 20-1, 20-2, and 20-3 have a rectangular parallelepiped shape and have a flat main surface 21 (21-1, 21-2, and 21-3) and a bonding surface 22 (22-1,22-2, and 22-3) that is a flat surface perpendicular to the main surface 21.

The subcarriers 20-1, 20-2, and 20-3 are made of, for example, aluminum nitride (AlN), aluminum oxide (Al₂O₃), silicon (Si), etc.

Metal films 75, 76 are provided between the subcarrier 20 and the laser element 30 (see FIG. 2). The subcarrier 20 and the laser element 30 are connected through the metal films 75, 76. Any known method can be used to form the metal films 75, 76, and there is no particular restriction on the method, but known methods such as sputtering, vapor deposition, and application of a metal paste can be used. The metal films 75, 76 include one or more metals selected from the group consisting of gold (Au), platinum (Pt), silver (Ag), lead (Pb), indium (In), nickel (Ni), titanium (Ti) and tantalum (Ta), tungsten (W), an alloy of gold (Au) and tin (Sn), a tin (Sn)-silver (Ag)-copper (Cu) solder alloy (SAC), SnCu, InBi, SnPdAg, SnBiIn, and PbBiIn, and may be composed of one or more metals selected from this group.

The optical waveguide layer 50 has at least an optical waveguide that guides the laser light emitted from the laser element. There are no particular limitations on this optical waveguide layer, and for example, a known configuration can be used as the optical waveguide layer. An example of an optical waveguide layer is shown hereinafter.

The optical waveguide layer 50 has four end faces 50A, 50B, 50C, and 50D. The optical waveguide layer 50 shown in FIG. 1 is a rectangle with four 90° corners when viewed from a plane (z direction), but is not limited to a rectangle with four 90° corners. Hereinafter, the end face 50A is also referred to as the incident surface 50A, and the end faces 50B and 50C are also referred to as the emission surfaces 50B and 50C, respectively.

The optical waveguide layer 50 is a layer that performs the function of a PLC (Planar Lightwave Circuit). Moreover, the optical waveguides 51-1, 51-2, 51-3, 51-4, and 51-5 correspond to the cores in an optical fiber.

The optical waveguide layer 50 is formed on the optical waveguide substrate 40, and as described above, the laser element 30 is mounted on the subcarrier 20.

The optical waveguide substrate 40 has four end faces 40A, 40B, 40C, and 40D. In FIG. 1, the optical waveguide substrate 40 is a rectangle with four 90° corners that overlap with the optical waveguide layer 50 in a plan view (as viewed from the z direction), but is not limited to a rectangle with four 90° corners. Hereinafter, the end face 40A will also be referred to as the bonding surface 40A, and the end faces 40B and 40C will also be referred to as the emission surfaces 40B and 40C, respectively.

The optical waveguide substrate 40 and the subcarrier 20 are integrated by eutectic bonding. This eutectic bonding allows for accurate optical axis positioning and also allows for miniaturization.

The optical waveguide substrate 40 is made of, for example, silicon (Si). The optical waveguide layer 50 is fabricated on the main surface 41 so as to be integrated with the optical waveguide substrate 40 by semiconductor processes including well-known photolithography and dry etching used in forming fine structures such as integrated circuits.

As shown in FIG. 1, the optical waveguide layer 50 is provided with optical waveguides 51-1, 51-2, and 51-3, the same number as the laser elements 30-1, 30-2, and 30-3, an optical waveguide 51-4 where the optical waveguides 51-1, 51-2, and 51-3 join, an optical waveguide 51-5 for monitoring that branches off from the optical waveguide 51-4, and a cladding 52 that surrounds the optical waveguides 51-1, 51-2, 51-3, 51-4, and 51-5. There are no particular limitations on the thickness of the cladding 52 and the width direction dimension of the optical waveguides 51-1, 51-2, 51-3, 51-4, and 51-5. For example, optical waveguides 51-1, 51-2, 51-3, 51-4, and 51-5, each having a width dimension of about several microns, are disposed in cladding 52, which has a thickness of about 50 μm.

The optical waveguides 51-1, 51-2, 51-3, 51-4, and 51-5 and cladding 52 are made of, for example, a glass material (e.g., quartz glass). In this case, the optical waveguide layer 50 is sometimes called a quartz-based PLC. The refractive indexes of the optical waveguides 51-1, 51-2, 51-3, 51-4, and 51-5 are higher than the refractive index of the cladding 52 by a predetermined value. As a result, light incident on each of the optical waveguides 51-1, 51-2, 51-3, 51-4, and 51-5 propagates through each of the optical waveguides while being totally reflected at the interface between each of the optical waveguides and the cladding 52. The optical waveguides 51-1, 51-2, 51-3,51-4, and 51-5 are doped with an impurity such as germanium (Ge) in an amount corresponding to the above-mentioned predetermined value.

As shown in FIG. 1, the optical waveguides 51-1, 51-2, and 51-3 are gathered together just before reaching the emission surface 50C of the optical waveguide layer 50. That is, the optical waveguides 51-1,51-2, and 51-3 merge sequentially as they move forward in the x-direction, and merge into one optical waveguide 51-4. The optical waveguide 51-4 reaches the emission surface 50C. Furthermore, the optical waveguide 51-5 for monitoring branches off from the optical waveguide 51-4. The optical waveguide 51-5 reaches the emission surface 50B perpendicular to the emission surface 50C of the optical waveguide layer 50.

By eutectic bonding between the optical waveguide substrate 40 and the subcarrier 20, the precise alignment of the axes is made so that the centers of the incident ports of the optical waveguides 51-1, 51-2, and 51-3 of the optical waveguide layer 50 are almost aligned with the optical axes of the emitted light from the corresponding laser elements 30-1, 30-2, and 30-3, under which each of the optical waveguides and each of the laser elements are disposed in face-to-face relationship with each other.

As shown in FIG. 2, the optical waveguide substrate 40 and the subcarrier 20 are arranged so that the incident surface 50A of the optical waveguide layer 50 faces the emission surface 30A (30-1A) of the laser element 30. In detail, the emission port 31-1 of the laser element 30-1 faces the incident port 51-1A of the optical waveguide 51-1. In the y and z directions, the optical axis of the blue light emitted from the laser element 30-1 and the center of the incident port 51-1A approximately overlap. Similarly, the emission port of the laser element 30-2 faces the incident port of the optical waveguide 51-2. In the y and z directions, the optical axis of the green light emitted from the laser element 30-2 and the center of the entrance approximately overlap. The emission port of the laser element 30-3 faces the incident port of the optical waveguide 51-3. In the y and z directions, the optical axis of the red light emitted from laser element 30-3 and the center of the incident port approximately overlap.

As shown in FIG. 1, the blue light, green light, and red light emitted from laser elements 30-1, 30-2, and 30-3 are incident on optical waveguides 51-1, 51-2, and 51-3, respectively, and then propagate through the respective optical waveguides 51-1, 51-2, and 51-3. The blue light and green light propagating through optical waveguides 51-1 and 51-2 are combined at the junction position 57-1. The combined blue light and green light and the red light propagating through the optical waveguide 51-3 are combined at the junction position 57-2. The RGB light combined at the junction position 57-2 propagates through optical waveguide 51-4, and a part of the RGB light reaches the emission surface 50C and is emitted from emission surface 50C. At the same time, a portion of the RGB light multiplexed at the junction 57-2 is branched from the optical waveguide 51-4 at the branching position 57-3, propagates through the monitor optical waveguide 51-5, reaches the emission surface 50B, and is emitted from the emission surface 50B. The RGB light emitted from the optical waveguide 51-5 is received by a photodetector (PD).

It is preferable that the optical waveguides 51-1, 51-2, 51-3, and 51-5 are each connected to the optical waveguide 51-4 with a curvature radius equal to or greater than a predetermined radius of curvature so that no light leaks from the optical waveguides 51-1, 51-2, 51-3, and 51-5.

The optical waveguides 51-1, 51-2, 51-3, 51-4, and 51-5 may be made of lithium niobate (LiNbO₃) films. In this case, the optical waveguide substrate 40 may be, for example, a sapphire substrate, a Si substrate, or a thermally oxidized silicon substrate.

The bonding surfaces 22 (22-1, 22-2, and 22-3) of the individual subcarriers 20-1, 20-2, and 20-3 and the bonding surface 40A (40A-1, 40A-2, and 40A-3) of the optical waveguide substrate 40 are joined through multiple metal films 70 (70-1, 70-2, and 70-3).

The metal film 70 is disposed between the bonding surfaces 22-1, 22-2, 22-3 of the individual subcarriers 20-1, 20-2, 20-3 and the multiple bonding surfaces 40A (40A-1, 40A-2, 40A-3) of the optical waveguide substrate 40 that correspond to the bonding surfaces 22-1, 22-2, 22-3 and are spaced apart from one another.

The metal film 70 is not a continuously deposited film, but is disposed only on the spaced apart bonding surfaces 40A-1, 40A-2, 40A-3, and is an electrically and spatially separated film, which suppresses the occurrence of capacitive coupling and thus suppresses crosstalk.

For the sake of convenience, the metal film 70 shown in FIG. 2 is drawn as a three-layer structure, reflecting the manufacturing process of the metal film 70 (or the bonding process between the subcarrier and the optical waveguide substrate). Also, when explaining the metal film 70, the respective three layers may be explained separately.

That is, for the sake of convenience, the metal film 70 is depicted as consisting of three layers: a first metal film 74 (74-1, 74-2, 74-3) disposed respectively on the bonding surfaces 22-1, 22-2, 22-3 of the individual subcarriers 20-1, 20-2, 20-3; second metal films 72 (72-1, 72-2, 72-3) disposed respectively on a plurality of bonding surfaces 40A-1, 40A-2, 40A-3 of the optical waveguide substrate 40 that correspond to the bonding surfaces 22-1, 22-2, 22-3, and that are disposed apart from one another; and a eutectic layer 73 disposed between the first metal film 74 and the second metal film 72. As a preferred eutectic bonding using the eutectic layer 73 is raised an Au-Sn bonding.

In actual bonding, if the first metal film and the second metal film are sufficiently thin, an alloy layer (eutectic layer) is formed, and the first metal film and the second metal film do not remain. On the other hand, if either the first metal film or the second metal film is thick, only the surface side of the thick metal film may become eutectic, leaving the part of the subcarrier side or the optical waveguide substrate side, and the other metal film may become eutectic in its entirety, but it may be difficult to distinguish them as clear layers (distinguishing the interface).

In this way, in actual bonding, the film structure of the metal film 70 varies depending on the conditions of the manufacturing process of the metal film 70, and the figure is a conceptual depiction of the characteristic aspects of the film structure.

For example, a structure in which one or both of the first metal film 74 and the second metal film 72 remain relatively, or a structure in which the entire first metal film 74 and the entire second metal film 72 are made alloyed to form a eutectic layer may sometimes be obtained.

The second metal film 72 disposed on the bonding surfaces 40A-1, 40A-2, and 40A-3 is preferably made of Sn or an alloy containing Sn, such as Sn-Ag-Cu (SAC).

The first metal film 74 disposed on the bonding surfaces 22-1, 22-2, and 22-3 is preferably a metal capable of forming a eutectic with Sn, and may be, for example, one selected from the group consisting of Au, Si, Al, Ni, Pb, Zn, and Pt, or an alloy thereof, but is more preferably made of Au or an alloy containing Au.

As shown in FIG. 2, the emission surface 50C of the optical waveguide layer 50 is inclined obliquely with respect to a plane perpendicular to the extension direction of the optical waveguide 51-4 at the emission surface 50C. FIG. 2 shows an example in which a portion of the emission surface 40C of the optical waveguide substrate 40 is also inclined obliquely with respect to a plane perpendicular to the extension direction of the optical waveguide 51-4 at the emission surface 50C, but the emission surface 40C of the optical waveguide substrate 40 does not necessarily have to be inclined obliquely.

As shown in FIG. 3, the monitor emission surface 50B of the optical waveguide layer 50 is inclined obliquely with respect to the extension direction of the optical waveguide 51-5 at the emission surface 50B. FIG. 3 shows an example in which a portion of the emission surface 40B of the optical waveguide substrate 40 is also inclined obliquely with respect to the extension direction of the optical waveguide 51-5 at the emission surface 50C, but the emission surface 40B of the optical waveguide substrate 40 does not necessarily have to be inclined obliquely.

In this way, by making the emission surface 50C where the optical waveguide 51-4 for RGB light reaches and the emission surface 50B where the optical waveguide 51-5 for monitoring reaches into obliquely inclined end faces, the light reflected at these end faces is directed toward the optical waveguide substrate 40 side, not toward the laser element 30 side. This makes it possible to suppress the return light to the laser element 30 and improve the oscillation instability of the laser element 30.

The inclination angle θ_{C} formed between the plane perpendicular to the extension direction of the optical waveguide 51-4 at the emission surface 50C of the optical waveguide layer 50 and the emission surface 50C is defined, for example, within a range of 1 to 10°. Similarly, the inclination angle θ_{B} formed between the plane perpendicular to the extension direction of the optical waveguide 51-5 at the emission surface 50B of the optical waveguide layer 50 and the emission surface 50B of the optical waveguide layer 50 is defined, for example, within a range of 1 to 10°.

By specifying the magnitude of the inclination angles θ_{B} and θ_{C} in this way, it is possible to suppress the return light to the laser element 30 while suppressing the loss of optical output from the optical waveguides 51-4 and 51-5.

If the emission surfaces 40B and 40C of the optical waveguide substrate 40 are also inclined obliquely, the inclination angle of the emission surfaces 40B and 40C may be, for example, 1 to 10°, similar to the emission surfaces 50B and 50C of the optical waveguide layer 50.

The obliquely inclined emission surfaces 50B, 50C of the optical waveguide layer 50 and the obliquely inclined emission surfaces 40B, 40C of the optical waveguide substrate 40 can be formed by oblique processing such as obliquely polishing or obliquely etching the vertical end faces of the optical waveguide layer 50 and the optical waveguide substrate 40, which originally have an inclination angle of 0.

In the laser assembly 100A shown in FIG. 5, not only the emission surface 50C of the optical waveguide layer 50 and the monitor emission surface 50B of the optical waveguide layer 50, but also the incident surface 50A of the optical waveguide layer 50 are obliquely inclined with respect to a plane perpendicular to the extension direction of the optical waveguides 51-1, 51-2, and 51-3 at the incident surface 50A of the optical waveguide layer 50. The bonding surface 40A of the optical waveguide substrate 40 may also be obliquely inclined.

In this way, by forming the incident surface 50A of the optical waveguide layer 50 as an obliquely inclined end face, when the oblique processing of the emission surfaces 50B and 50C alone is insufficient to suppress the return light, the reflected light from the emission surfaces 50B and 50C can be directed toward the optical waveguide substrate 40 side, rather than the laser element 30 side. This makes it possible to further suppress the return light to the laser element 30, and to improve the oscillation instability of the laser element 30.

Here, it is desirable that the inclination angle θ_{A} formed between the plane perpendicular to the extension direction of the optical waveguides 51-1, 51-2, and 51-3 at the incident surface 50A of the optical waveguide layer 50 and the incident surface 50A is smaller than the inclination angles θ_{B} and θ_{C} at the respective emission surfaces 50B and 50C of the optical waveguide layer 50.

In this way, while the incidence loss from the laser element 30 to the optical waveguides 51-1, 51-2, and 51-3 is being suppressed by reducing the inclination angle θ_{A} of the incident surface 50A, the inclination angles θ_{B} and θ_{C} of the emission surfaces 50B and 50C are increased, thereby making it possible to effectively suppress the return light to the laser element 30.

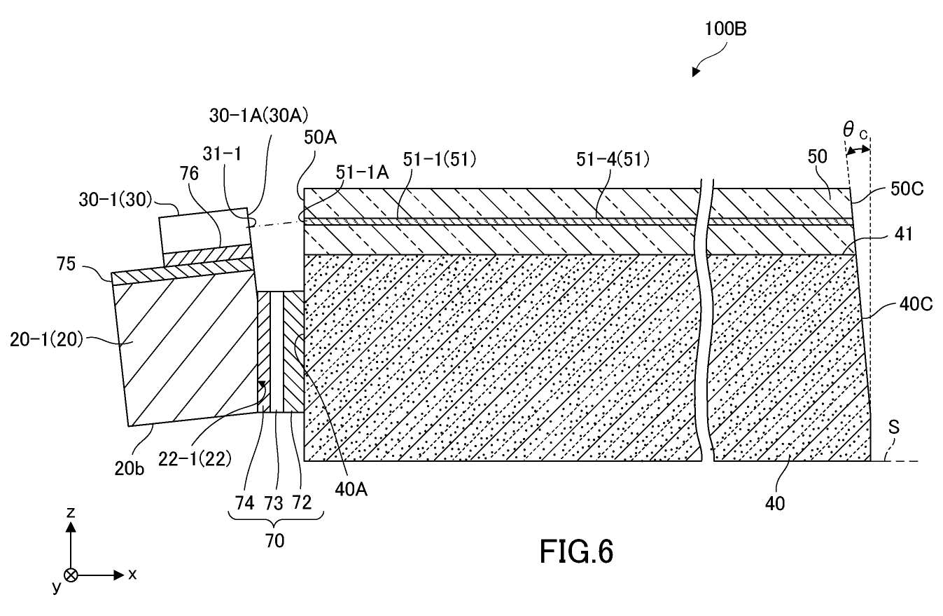

In the laser assembly 100B shown in FIG. 6, in addition to the fact that the emission surface 50C of the optical waveguide layer 50 and the monitor emission surface 50B of the optical waveguide layer 50 are inclined obliquely, the optical axis of the laser light emitted from the multiple laser elements 30 is also inclined obliquely with respect to the extension direction of the optical waveguides 51-1,51-2, and 51-3 at the incident surface 50A of the optical waveguide layer 50.

This means that, for example, the bonding surfaces 22-1, 22-2, and 22-3 of the multiple subcarriers 20-1, 20-2, and 20-3 with the optical waveguide substrate 40 are inclined obliquely with respect to a plane perpendicular to the optical axis of the laser light emitted from each of the multiple laser elements 30-1, 30-2, and 30-3.

In this way, by forming the bonding surfaces 22 of the multiple subcarriers 20 as obliquely inclined end faces, when the oblique processing of the emission surfaces 50B, 50C alone is insufficient for suppressing the return light, it is possible to prevent the reflected light from the emission surfaces 50B, 50C from heading toward the emission port of the laser element 30. This makes it possible to further suppress the return light to the laser element 30, and to improve the oscillation instability of the laser element 30.

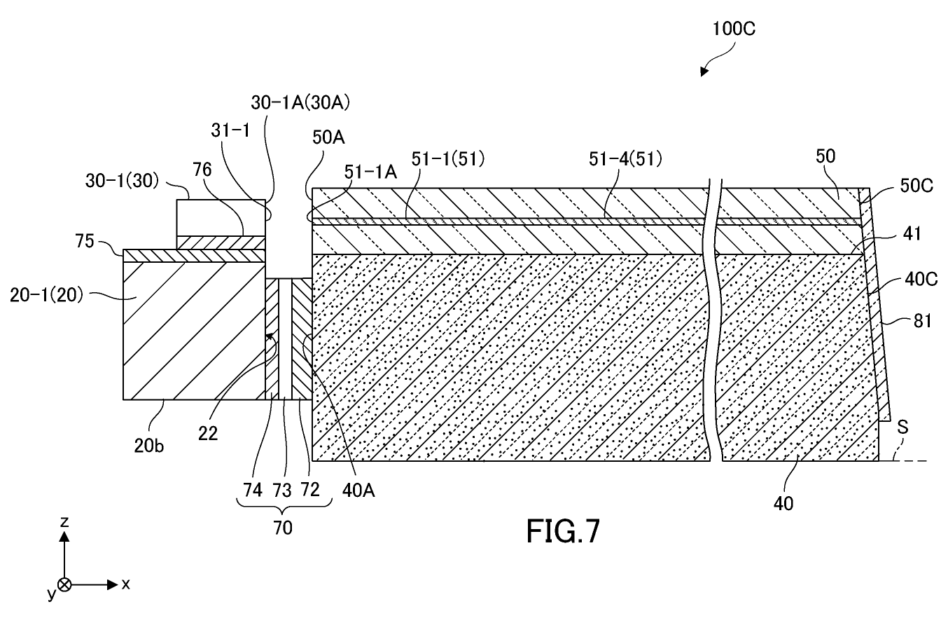

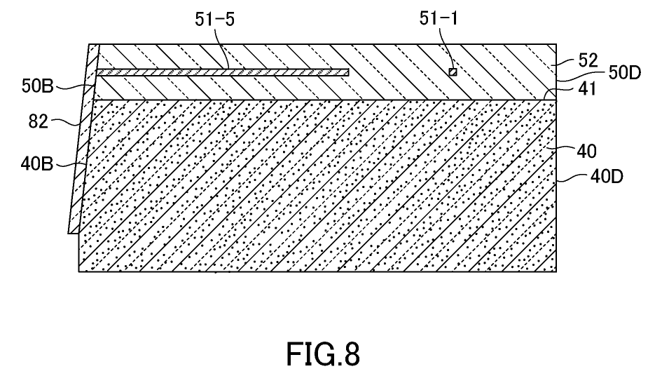

In the laser assembly 100C shown in FIG. 7, an anti-reflection film 81 with a refractive index different from that of the optical waveguide layer 50 is formed on the obliquely inclined emission surface 50C of the optical waveguide layer 50 and the obliquely inclined emission surface 40C of the optical waveguide substrate 40. Similarly, as shown in FIG. 8, an anti-reflection film 82 having a refractive index different from that of the optical waveguide layer 50 may be formed on the obliquely inclined emission surface 50B of the optical waveguide layer 50 and the obliquely inclined emission surface 40B of the optical waveguide substrate 40.

The anti-reflection films 81 and 82 are films for preventing the emission light from the optical waveguide layer 50 from being reflected in the opposite direction to the direction in which it enters each surface from the emission surface 50C or the emission surface 50B, and for increasing the transmittance of the emission light. The anti-reflection films 81 and 82 are multi-layer films formed by alternately stacking, for example, a plurality of types of dielectrics with a predetermined thickness corresponding to the wavelengths of the incident light, that is, red light, green light, and blue light. The aforementioned dielectrics to be raised include, for example, titanium oxide (TiO₂), tantalum oxide (Ta₂O₅), silicon oxide (SiO₂), and aluminum oxide (Al₂O₃).

The anti-reflection films 81, 82 can be formed on the emission surface 50C of the optical waveguide layer 50, the emission surface 40C of the optical waveguide substrate 40, the emission surface 50B of the optical waveguide layer 50, and the emission surface 40B of the optical waveguide substrate 40, for example, by film formation or optical bonding.

By providing the anti-reflection films 81, 82 on the emission surfaces 50B, 50C of the optical waveguide layer 50, it is possible to suppress return light to the laser element 30.

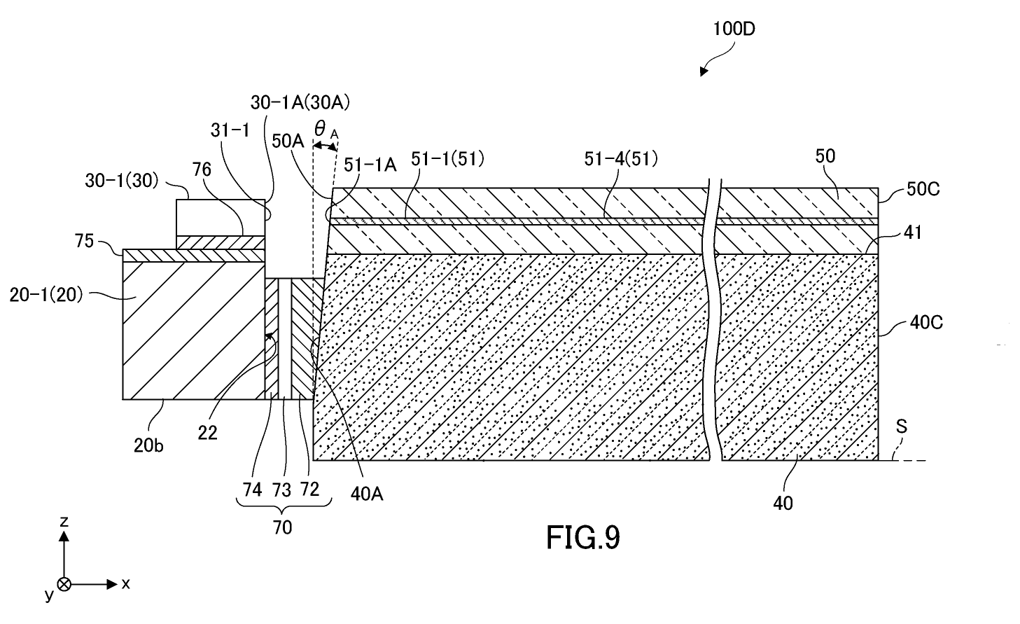

In the laser assembly 100D shown in FIG. 9, the emission surface 50C of the optical waveguide layer 50 and the monitor emission surface 50B of the optical waveguide layer 50 are not inclined, and only the incident surface 50A of the optical waveguide layer 50 is inclined obliquely with respect to a plane perpendicular to the extension direction of the optical waveguides 51-1, 51-2, and 51-3 at the incident surface 50A of the optical waveguide layer 50.

As will be seen from the above mentioned description, even if only the incident surface 50A of the optical waveguide layer 50 is an obliquely inclined end face, the reflected light from the emission surfaces 50B and 50C can be refracted at the incident surface 50A so as not to go toward the exit of the laser element 30. This results in suppressing the return light to the laser element 30, thereby improving the oscillation instability of the laser element 30.

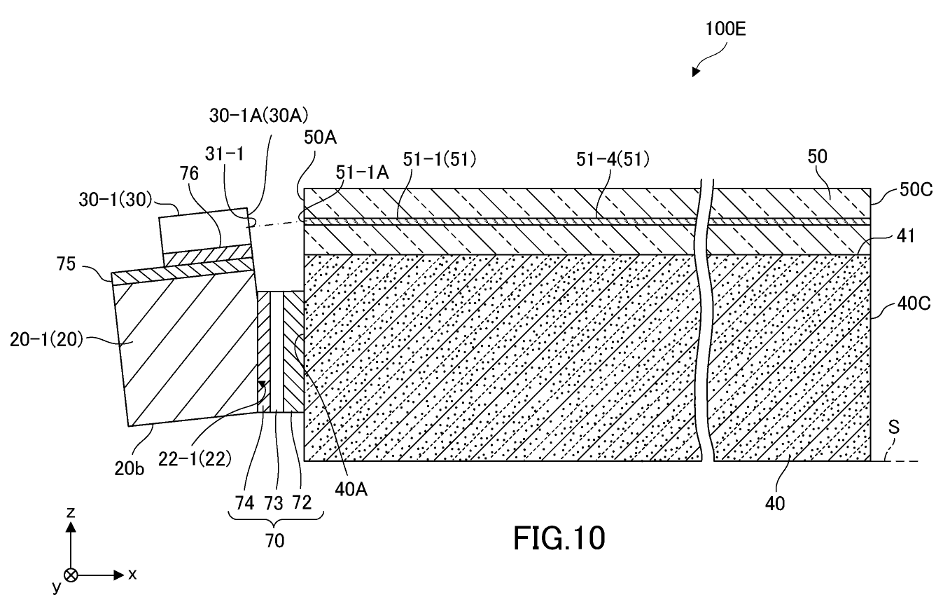

In the laser assembly 100E shown in FIG. 10, the emission surface 50C of the optical waveguide layer 50 and the monitor emission surface 50B of the optical waveguide layer 50 are not inclined, and the bonding surfaces 22-1, 22-2, and 22-3 of the subcarriers 20-1, 20-2, and 20-3 with the optical waveguide substrate 40 are inclined obliquely with respect to a plane perpendicular to the optical axis of the laser light emitted from each of the laser elements 30-1, 30-2, and 30-3.

As will be seen from the above mentioned description, even if only the bonding surfaces 22 of the subcarriers 20 are inclined obliquely, it is possible to prevent the reflected light from the emission surfaces 50B and 50C from heading toward the emission port of the laser element 30. This suppresses the return light to the laser element 30, and improves the oscillation instability of the laser element 30.

Further. in the above description, the end face 50B is the obliquely inclined emission surface for the monitor, and the end face 50C is the obliquely inclined emission surface for RGB light, but the present disclosure is not limited to this example. For example, the emission surface for the monitor may be the obliquely inclined end face 50C or end face 50D, and the emission surface for RGB light may be the obliquely inclined end face 50B or end face 50D.

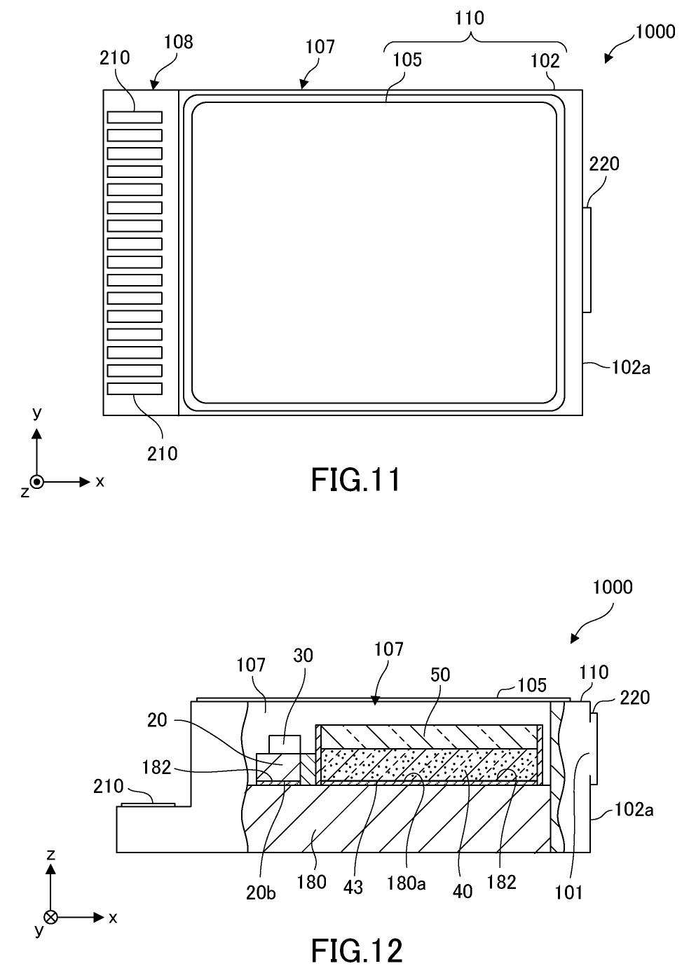

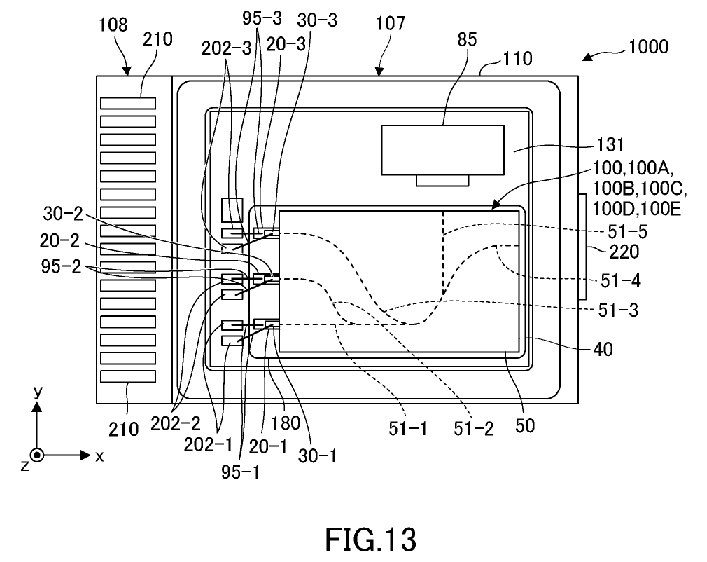

FIG. 11 is a plan view schematic diagram of the laser module of this embodiment. FIG. 12 is a diagram showing a cross section of a laser assembly that is placed inside the laser module shown in FIG. 11 by cutting a part of the laser module in the X-Z plane. FIG. 13 is a plan view of the laser module with the cover removed.

The laser module 1000 is housed in a package 110 with any one of the laser assemblies 100, 100A, 100B, and 100C according to the above embodiments mounted on the upper surface 180a of the base 180.

In the laser assembly 100, the subcarrier 20 and the optical waveguide substrate 40 are bonded by metal eutectic bonding, so that the occurrence of misalignment due to the heating process is significantly suppressed as compared to a configuration in which they are bonded by adhesive.

The package 110 may include known constituent elements other than the laser assembly according to the above embodiments. For example, as shown in FIG. 13, the package 110 can house a PD 85 therein.

The light receiving surface of the PD 85 and the emission port of the monitor optical waveguide 51-5 are aligned with each other by their optical axes. The PD 85 can be exemplified to include a semiconductor detector using a Si pn junction, a semiconductor detector using an InGaAs pn junction, and a spin photodetector having a magnetoresistance effect function achieved by stacking a first ferromagnetic layer, a spacer layer, and a second ferromagnetic layer.

When the laser module 1000 is equipped with the PD 85, the fluctuation in the optical output of the laser element can be checked by observing the current flowing through the PD 85. In addition, the current flowing through the PD 85 can be monitored to control the driving current of the laser element so that the output is constant.

The package 110 includes a main body 102 having a cavity structure and a cover 105 that covers the main body 102. The main body 102 has a bottom on which the members to be housed are placed, and a sidewall portion 102a that is arranged to surround the members from the sides.

A light-transmitting window (opening) 101 through which the laser light emitted from the laser element 30 can optically pass is formed in the side wall portion 102a in the vicinity of the emission portion of the laser light emitted from the laser module 1000 among the side wall portions of the storage portion 107.

The opening 101 is formed with its center approximately at a position where it intersects with the optical axis of the laser light emitted from the side wall portion 102a. The opening 101 is tightly covered by a glass plate 220 from the outside of the side wall portion 102a. In other words, the storage portion 107 is hermetically sealed by the glass plate 220 in addition to the cover 105. Here, the glass plate 220 is used for hermetic sealing, but it is not limited to a glass plate as long as it is a material through which the laser light can pass. An anti-reflection film (not shown) may be provided on both plate surfaces of the glass plate 220.

The electrode portion 108 is disposed on the front side of the housing portion 107 in the x direction, i.e., rearward in the x direction. The upper surface of the electrode portion 108 is located lower than the upper surface of the housing portion 107. The bottom surface of the electrode portion 108 is located at approximately the same height as the bottom surface of the housing portion 107. A plurality of external electrode pads 210 are provided on the upper surface of the electrode portion 108 at intervals in the y direction.

The bottom surface 43 of the optical waveguide substrate 40 may be bonded to the upper surface 180a (one inner surface) of the base 180 through an adhesive layer 182. To enhance thermal conductivity, this adhesive layer 182 is made of a material in which a filler is mixed with resin. Further, the resin that constitutes the adhesive layer 182 is raised as one of the examples to include epoxy resin. As a filler to enhance the thermal conductivity of the resin, copper powder, aluminum powder, alumina powder, etc. can be used.

In order to maintain a certain level of thermal conductivity, it is preferable for the adhesive layer 182 to have a thermal conductivity of 0.5 W/m·K or more, more preferably a thermal conductivity of 1 W/m·K or more, and much more preferably a thermal conductivity of 4 W/m·K or more.

As shown in FIG. 13, a plurality of internal electrode pads 202 (202-1, 202-2, 202-3) are provided at intervals in the y direction on the bottom wall portion 131 between the base 180 below the subcarrier 20 and the external electrode pad 210 in the x direction.

The laser elements 30 and the subcarrier 20 are connected to the internal electrode pads 202 corresponding to each laser element 30 among the plurality of internal electrode pads 202 by wires 95 using a method such as wire bonding. For example, the laser element 30-1 and the subcarrier 20-1 are each individually connected to each of the two internal electrode pads 202-1 by wires 95-1. The laser element 30-2 and the subcarrier 20-2 are each individually connected to each of the two internal electrode pads 202-2 by wires 95-2. Each of the laser element 30-3 and subcarrier 20-3 is individually connected to each of the two internal electrode pads 202-3 by wire 95-3.

Each of the internal electrode pads 202-1, 202-2, and 202-3 is connected to each of external electrode pads 210 different from each other. As described above, each of the external electrode pads 210 electrically connected to each of the internal electrode pads 202-1, 202-2, and 202-3 are electrically connected to a power supply (not shown) and the like. In other words, in the laser assembly 100, the laser element 30 is connected to a power supply (not shown) by wire 95, the internal electrode pads 202-1, 202-2, and 202-3, and the external electrode pads 210. When power is supplied from a power source (not shown) to the external electrode pads 210 corresponding to the internal electrode pads 202-1, 202-2, and 202-3, blue light, green light, and red light are emitted from the laser elements 30-1, 30-2, and 30-3.

The XR glasses according to this embodiment are equipped with the laser module according to the above embodiment. XR glasses (eyeglasses) are glasses-type terminals, and XR is a general term for virtual reality (VR), augmented reality (AR), and mixed reality.

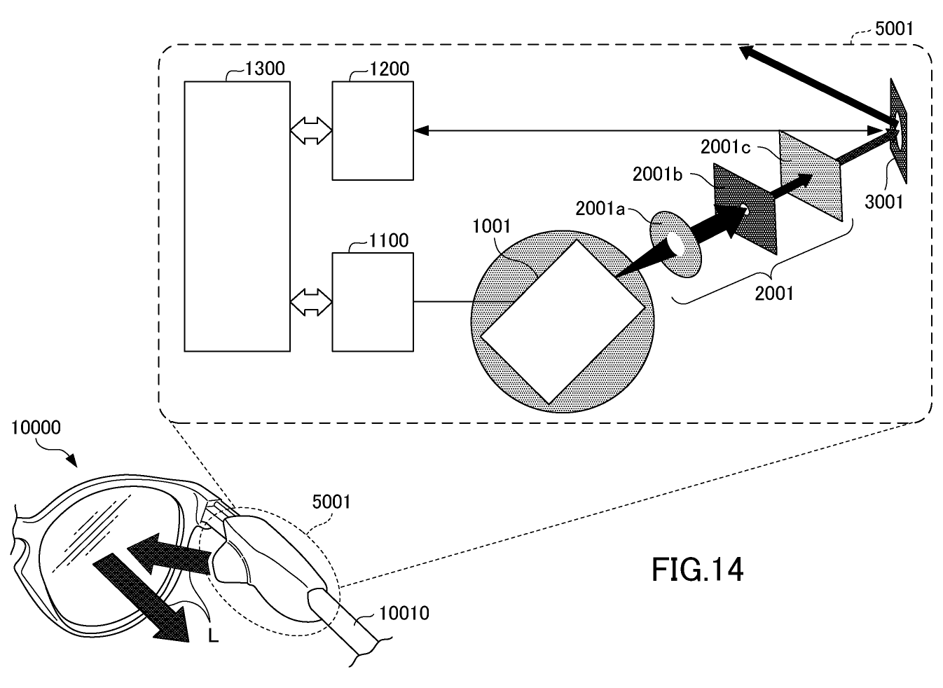

FIG. 14 shows a conceptual diagram for explaining the XR glasses according to this embodiment. The XR glasses 10000 shown in FIG. 14 are equipped with a laser module 1001 on an optical engine 5001 provided in a frame 10010. The symbol L is image display light.

In FIG. 14, the laser module 1001, the optical scanning mirror 3001, and the optical system 2001 connecting the laser module 1001 and the optical scanning mirror 3001, which are provided in the XR glasses 10000, are collectively referred to as the optical engine 5001 in this specification. As the laser module 1001, any of the laser modules according to the above-mentioned embodiments can be used.

As the light source in the laser module 1001, for example, one having RGB laser elements of the laser element 30-1, the laser element 30-2, and the laser element 30-3 and a near-infrared laser element can be used.

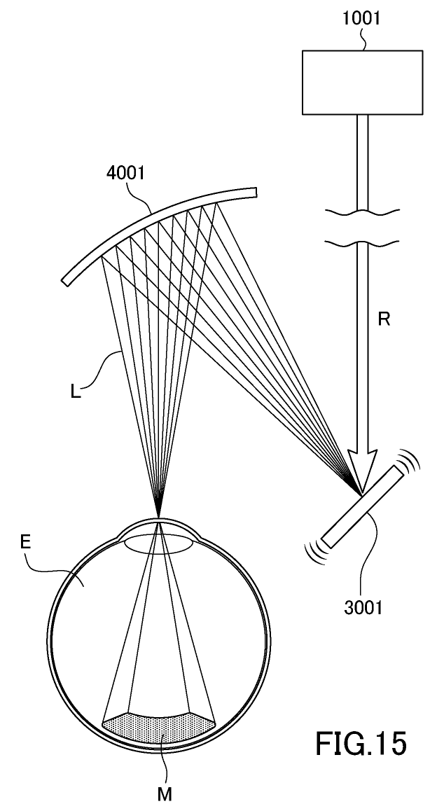

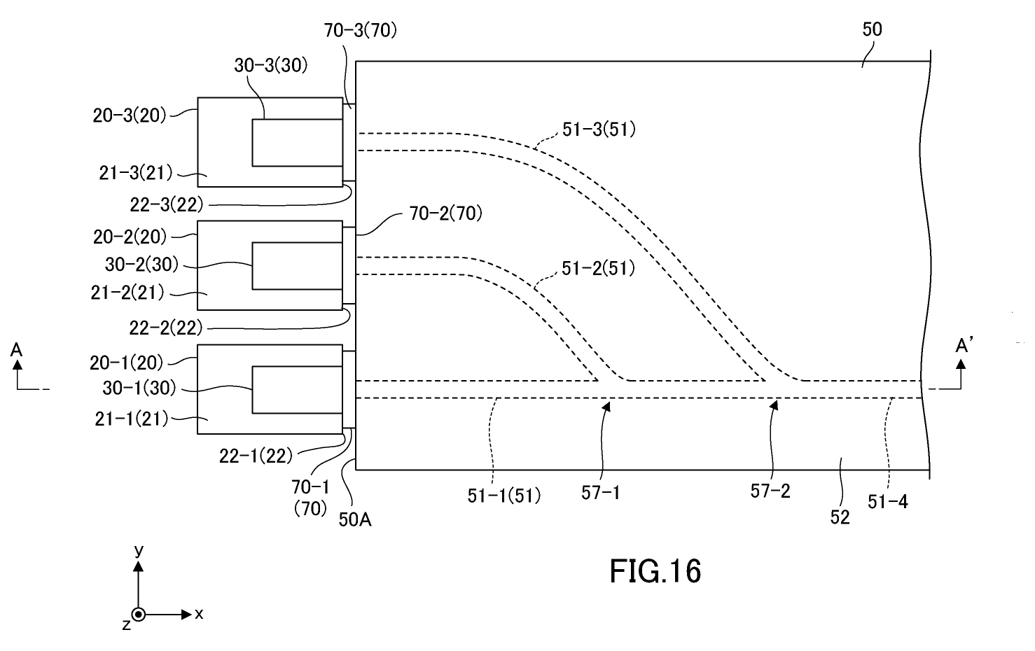

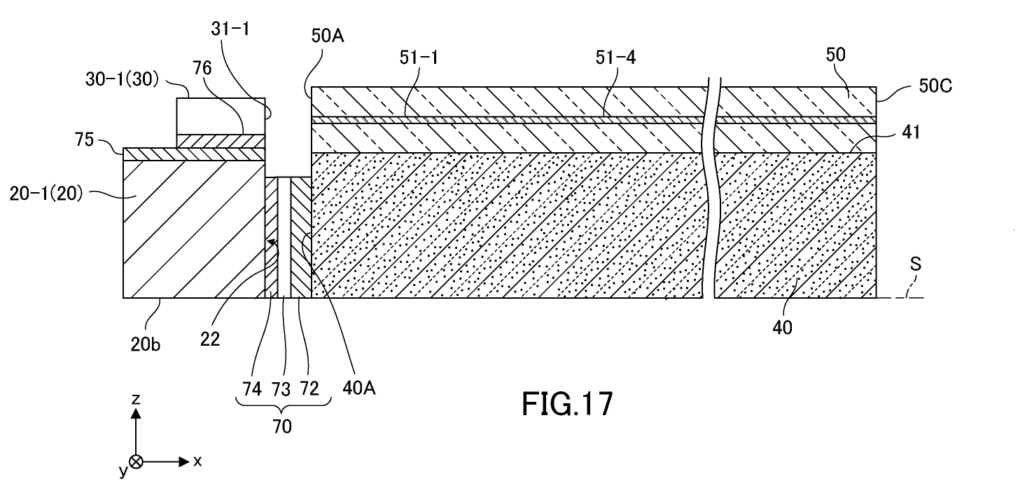

As shown in FIG. 15, the laser light emitted from the laser module 1001 attached to the eyeglass frame is reflected by the optical scanning mirror 3001, and the reflected light is reflected by the mirror 4001 that reflects it toward the person's eyeball E, enters the person's eyeball E, and an image (video) can be directly projected onto the retina M.

By providing an eye tracking mechanism, an image is projected directly onto the retina while performing eye tracking. As one of the eye tracking mechanisms, a publicly known eye tracking mechanism can be used.

The optical scanning mirror 3001 is, for example, a MEMS mirror that scans the laser light emitted from the laser module 1001. In order to project a 2D image, it is preferable that the mirror is a two-axis MEMS mirror that vibrates to reflect the laser light by changing the angle in the horizontal direction (X direction) and the vertical direction (Y direction).

The optical system 2001 that optically processes the laser light emitted from the laser module 1001 has a collimator lens 2001a, a slit 2001b, and an ND filter 2001c. This optical system is raised as one of examples, and may have other configuration to be used.

The optical engine 5001 has a laser driver 1100, an optical scanning mirror driver 1200, and a video controller 1300 that controls these drivers.

### APPENDIX

One aspect of the present disclosure provides the laser module, in which the inclination angle formed between the plane perpendicular to the extension direction of the optical waveguide at each of the emission surfaces of the optical waveguide layer and each of the emission surfaces of the optical waveguide layer is defined within a range of 1° to 10°.

One aspect of the present disclosure provides the laser module, in which the incident surface of the optical waveguide layer is inclined obliquely with respect to a plane perpendicular to the extension direction of the optical waveguide at the incident surface.

One aspect of the present disclosure provides the laser module according to aspect 3, in which the inclination angle formed between the plane perpendicular to the extension direction of the optical waveguide at the incident surface of the optical waveguide layer and the incident surface of the optical waveguide layer is smaller than the inclination angle of each of the emission surfaces of the optical waveguide layer.

One aspect of the present disclosure provides the laser module, in which the bonding surface of each of the plurality of laser element bases with the optical waveguide substrate is inclined obliquely with respect to a plane perpendicular to the optical axis of the laser light respectively emitted from the plurality of laser elements.

One aspect of the present disclosure provides the laser module, in which an anti-reflection film with a refractive index different from that of the optical waveguide layer is formed on at least one of the emission surfaces of the optical waveguide layer.

Although the disclosure has been described with respect to only a limited number of embodiments, those skilled in the art, having benefit of this disclosure, will appreciate that various other embodiments may be devised without departing from the spirit and scope of the present disclosure. Accordingly, the technical scope of the disclosed subject matter should be limited only by the attached claims.

### DESCRIPTION OF REFERENCE NUMERALS AND SIGNS

20 Subcarrier (laser element base)

21 Main surface

22 Bonding surface

30 Laser element

40 Optical waveguide substrate

40A Bonding surface (end face)

40B, 40C Emission surface (end face)

41 Main surface

50 Optical waveguide layer

50A Incident surface (end face)

50B, 50C Emission surface (end face)

51 Optical waveguide

81, 82 Anti-reflection film

85 PD

100, 100A, 100B, 100C, 100D, 100E Laser assembly

1000, 1001 Laser module

3001 Optical scanning mirror

5001 Optical engine

10000 XR glasses

What is claimed is:

1. A laser module comprising:
a plurality of laser element bases;
a plurality of laser elements mounted on the respective main surfaces of the plurality of laser element bases; and
an optical waveguide substrate having an optical waveguide layer on its main surface, the optical waveguide layer having an optical waveguide for guiding laser light respectively emitted from the plurality of laser elements;
wherein the optical waveguide layer has at least one emission surface, and each of the emission surfaces is inclined obliquely with respect to a plane perpendicular to the extension direction of the optical waveguide at the emission surface.

2. The laser module according to claim 1,
wherein the inclination angle formed between the plane perpendicular to the extension direction of the optical waveguide at each of the emission surfaces of the optical waveguide layer and each of the emission surfaces of the optical waveguide layer is defined within a range of 1° to 10°.

3. The laser module according to claim 1,
wherein the incident surface of the optical waveguide layer is inclined obliquely with respect to a plane perpendicular to the extension direction of the optical waveguide at the incident surface.

4. The laser module according to claim 3,
wherein the inclination angle formed between the plane perpendicular to the extension direction of the optical waveguide at the incident surface of the optical waveguide layer and the incident surface of the optical waveguide layer is smaller than the inclination angle of each of the emission surfaces of the optical waveguide layer.

5. The laser module according to claim 1,
wherein the bonding surface of each of the plurality of laser element bases with the optical waveguide substrate is inclined obliquely with respect to a plane perpendicular to the optical axis of the laser light respectively emitted from the plurality of laser elements.

6. The laser module according to claim 1,
wherein an anti-reflection film with a refractive index different from that of the optical waveguide layer is formed on at least one of the emission surfaces of the optical waveguide layer.

7. The laser module according to claim 1,
further comprising a photodetector that receives light propagated through the optical waveguide and emitted from at least one of the emission surfaces.

8. The laser module according to claim 1,
wherein the plurality of laser elements include:
a laser element that emits the red laser light having a peak wavelength of 630 nm or more and 830 nm or less;
a laser element that emits the green laser light having a peak wavelength of 500 nm or more and 550 nm or less; and
a laser element that emits the blue laser light having a peak wavelength of 380 nm or more and 500 nm or less.

9. The laser module according to claim 1,
wherein the optical waveguide layer is a PLC (Planar Lightwave Circuit) formed of a glass material.

10. The laser module according to claim 1,
wherein the optical waveguide layer is a PLC formed of a lithium niobate film.

11. The laser module according to claim 1,
wherein the optical waveguide substrate is formed of silicon.

12. The laser module according to claim 10,
wherein the optical waveguide substrate is formed of sapphire, silicon, or thermally oxidized silicon.

13. A laser module comprising:
a plurality of laser element bases;
a plurality of laser elements mounted on the respective main surfaces of the plurality of laser element bases; and
an optical waveguide substrate having an optical waveguide layer on its main surface, the optical waveguide layer having an optical waveguide for guiding laser light respectively emitted from the plurality of laser elements;
wherein the incident surface of the optical waveguide layer is inclined obliquely with respect to a plane perpendicular to the extension direction of the optical waveguide at the incident surface.

14. The laser module according to claim 13,
wherein the optical waveguide layer is a PLC formed of a glass material.

15. The laser module according to claim 13,
wherein the optical waveguide layer is a PLC formed of a lithium niobate film.

16. A laser module comprising:
a plurality of laser element bases;
a plurality of laser elements mounted on the respective main surfaces of the plurality of laser element bases; and
an optical waveguide substrate having an optical waveguide layer on its main surface, the optical waveguide layer having an optical waveguide for guiding laser light respectively emitted from the plurality of laser elements;
wherein the bonding surface of each of the plurality of laser element bases with the optical waveguide substrate is inclined obliquely with respect to a plane perpendicular to the optical axis of the laser light respectively emitted from the plurality of laser elements.

17. The laser module according to claim 16,
wherein the optical waveguide layer is a PLC formed of a glass material.

18. The laser module according to claim 16,
wherein the optical waveguide layer is a PLC formed of a lithium niobate film.

19. An optical engine comprising:
a laser module according to claim 1; and
an optical scanning mirror that scans the light emitted from the laser module.

20. XR glasses comprising the optical engine according to claim 19.
